(19) United States
(12) Patent Application Publication
(10) Pub. No.: US 2024/0118600 A1
(43) Pub. Date: Apr. 11, 2024

(54) Illumination assembly and projection device

(71) Applicant: Coretronic Corporation, Hsin-Chu (TW)

(72) Inventor: SHIH CHEN CHIOU, Hsin-Chu (TW)

(21) Appl. No.: 18/376,453

(22) Filed: Oct. 4, 2023

(30) Foreign Application Priority Data
Oct. 8, 2022 (CN) 202211221312.6

(51) Int. Cl. G03B 21/20; G02B 27/12

(52) U.S. Cl. CPC G03B 21/2066; G02B 27/126; G03B 21/2013

(57) ABSTRACT

An illumination assembly includes a light source module and a light guide module. The light source module provides first and second beams. The light guide module includes a first light guide triangular prism having a first surface, a second surface and a beam-splitting surface. The first surface is located on a transmission path of the first beam, and the beam-splitting surface is located on a transmission path of the second beam. The first light guide triangular prism includes a first light guide layer arranged on the second surface and a first beam-splitting layer arranged on the beam-splitting surface. The first light guide layer guides the first beam to the first beam-splitting layer. The first beam-splitting layer allows the second beam to pass therethrough and reflect the first beam, so that the first and second beams are emitted from the second surface. A projection device is also provided.

### CROSS-REFERENCE TO RELATED APPLICATION

This application claims the priority benefit of China application (No. 202211221312.6), filed on Oct. 8, 2022. The entirety of the above-mentioned patent application is hereby incorporated by reference herein and made a part of this specification.

### TECHNICAL FIELD

The disclosure relates to an illumination assembly suitable for a projection device and a projection device having the illumination assembly.

### BACKGROUND

With the requirements of the market for the brightness, color saturation, and service life of projection devices, the market demand for projection devices with more light sources is growing. In detail, the light sources can provide beams with different wavelengths, and the projection device can also be set with a light guide assembly to guide the beams provided by the light sources. However, most of the conventional light guide assemblies have the disadvantages of large size and complex structure, which makes the size of the projection device cannot be reduced, and the cost is also difficult to reduce.

The information disclosed in this “BACKGROUND” section is only for enhancement understanding of the background of the disclosure and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

An illumination assembly provided by the disclosure includes a light source module and a light guide module. The light source module is configured to provide a first beam and a second beam. The light guide module includes a first light guide triangular prism. The first light guide triangular prism has a first surface, a second surface, and a beam-splitting surface. The first surface is located on a transmission path of the first beam, and the beam-splitting surface is located on a transmission path of the second beam. The first light guide triangular prism includes a first light guide layer and a first beam-splitting layer. The first light guide layer is arranged on the second surface. The first beam-splitting layer is arranged on the beam-splitting surface. The first light guide layer is configured to guide the first beam to the first beam-splitting layer. The first beam-splitting layer is configured to allow the second beam to pass therethrough and reflect the first beam, so that the first beam and the second beam are emitted from the second surface.

A projection device provided by the disclosure includes an illumination system, a light valve and a projection lens. The illumination system is configured to provide an illumination beam. The light valve is arranged on a transmission path of the illumination beam and configured to convert the illumination beam into an image beam. The projection lens is arranged on a transmission path of the image beam and configured to project the image beam out of the projection device. The illumination system includes the aforementioned illumination assembly.

Other objectives, features, and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure and are incorporated in and constitute a part of this specification. The drawings illustrate embodiments of the disclosure and, together with the description, serve to explain the principles of the disclosure.

FIG. 1 is a sectional view of an illumination assembly according to an embodiment of the disclosure;

FIG. 2 is a three-dimensional schematic view of a light guide module of the illumination assembly of FIG. 1;

FIG. 3 is a schematic diagram of the spectrum of the beam provided by the light source module in FIG. 1;

FIG. 4 is a schematic view of an illumination assembly according to another embodiment of the disclosure;

FIG. 5 is a schematic view of an illumination assembly according to another embodiment of the disclosure;

FIG. 6 is a schematic view of an illumination assembly according to another embodiment of the disclosure;

FIG. 7 is a schematic view of an illumination assembly according to another embodiment of the disclosure;

FIG. 8 is a schematic view of a light guide module according to another embodiment of the disclosure;

FIGS. 9, 10, and 11 are schematic views of an illumination assembly according to another embodiment of the disclosure in different viewing angles;

FIG. 12 is a schematic view of an illumination assembly according to another embodiment of the disclosure;

FIG. 13 is a schematic view of an illumination assembly according to another embodiment of the disclosure;

FIG. 14 is a schematic view of an illumination assembly according to another embodiment of the disclosure;

FIG. 15 is a block diagram of a projection device according to an embodiment of the disclosure;

FIG. 16 is a schematic view of an illumination system of the projection device of FIG. 15;

FIG. 17 is a schematic view of an illumination system of a projection device according to another embodiment of the disclosure; and

FIG. 18 is a schematic view of an illumination system of a projection device according to another embodiment of the disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

The disclosure provides an illumination assembly and a projection device, which have the advantages of small volume, simple structure, and low cost. Other advantages and objectives of the disclosure may be further illustrated by the technical features broadly embodied and described as follows.

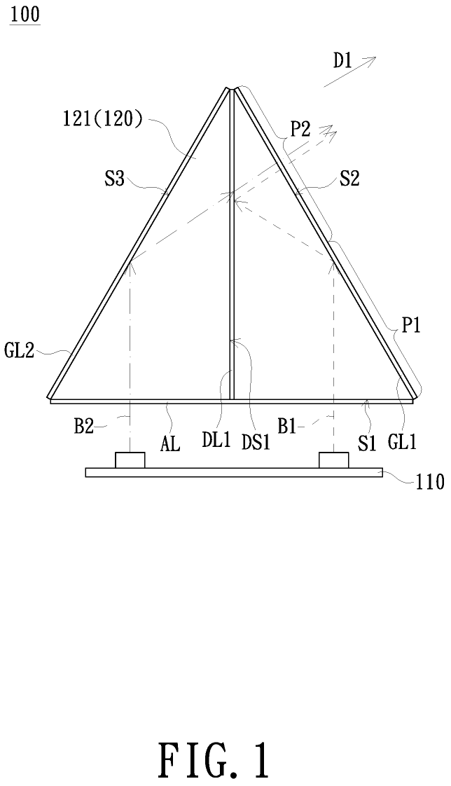

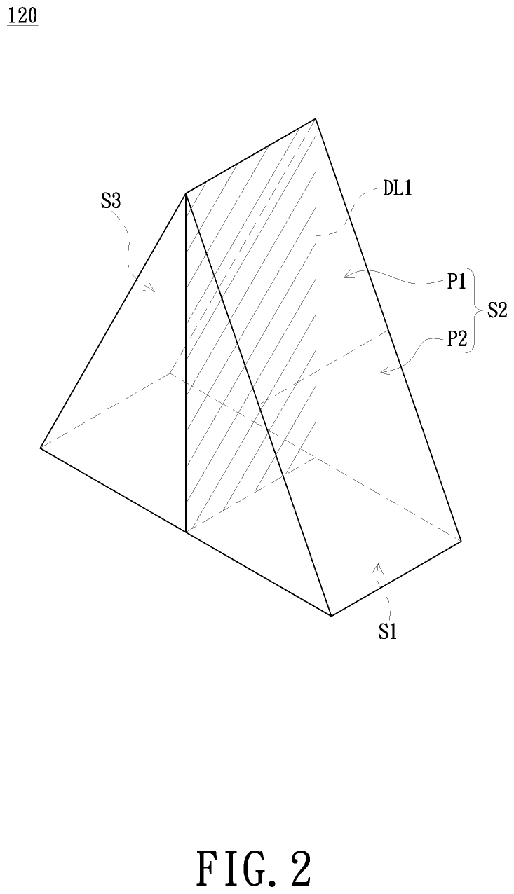

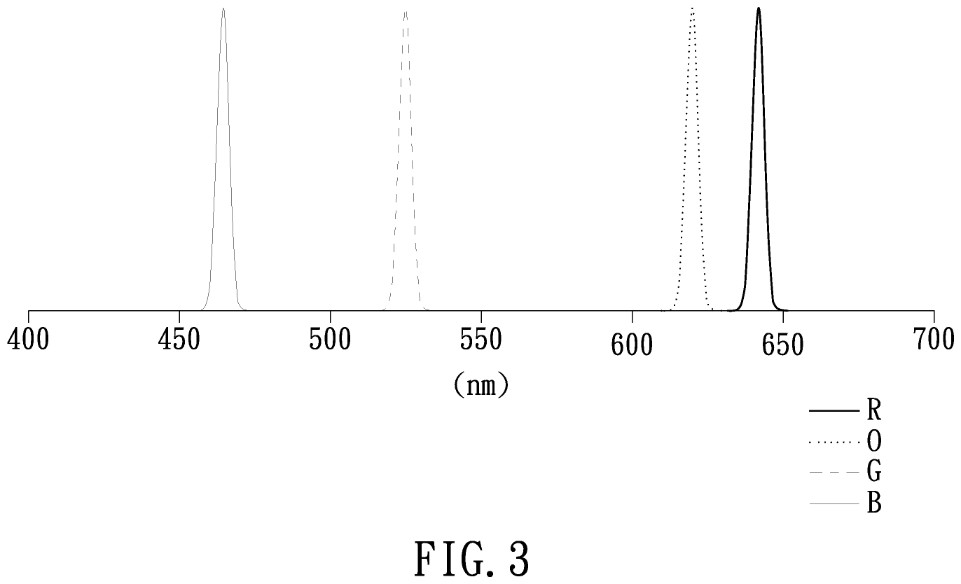

FIG. 1 is a sectional view of an illumination assembly according to an embodiment of the disclosure. FIG. 2 is a three-dimensional schematic view of a light guide module of the illumination assembly of FIG. 1. FIG. 3 is a schematic diagram of the spectrum of the beam provided by the light source module in FIG. 1. Referring to FIGS. 1 and 2, the illumination assembly 100 includes a light source module 110 and a light guide module 120. The light source module 110 is configured to provide a first beam B1 and a second beam B2. The light guide module 120 includes a first light guide triangular prism 121. The first light guide triangular prism 121 has a first surface S1, a second surface S2, and a beam-splitting surface DS1. The beam-splitting surface DS1 is, for example, a symmetrical plane inside the first light guide triangular prism 121. The first surface S1 is located on the transmission path of the first beam B1. The beam-splitting surface DS1 is located on the transmission path of the second beam B2. The first light guide triangular prism 121 includes a first light guide layer GL1 (shown in FIG. 1) and a first beam-splitting layer DL1 (shown in FIG. 1). The first light guide layer GL1 is arranged on the second surface S2. The first beam-splitting layer DL1 is arranged on the beam-splitting surface DS1. The first light guide layer GL1 is configured to guide the first beam B1 to the first beam-splitting layer DL1. The first beam-splitting layer DL1 is configured to allow the second beam B2 to pass therethrough and reflect the first beam B1 so that the first beam B1 and the second beam B2 are emitted from the second surface S2.

Refer to FIGS. 1 and 3 together. The first beam B1 and the second beam B2 provided by the light source module 110 can be two beams with different wavelengths. Further, the bandwidths of the first beam B1 and the second beam B2 on the spectrogram do not overlap each other. For example, the first beam B1 and the second beam B2 are two of blue beam B, green beam G, orange beam O, red beam R, infrared light beam, ultraviolet light beam, or other colored light beams. In this embodiment, the first beam B1 includes a red beam R, and the second beam B2 includes a blue beam B, for example. The light source module 110 of this embodiment can include a laser diode (LD), a light emitting diode (LED) module or a combination thereof, or other suitable light sources to provide beams with narrow wavelength bandwidth. The light source module 110 may include a plurality of excitation light sources arranged in an array, that is, the distance between each one of the excitation light source and the light guide module 120 is equal, so that the effect of uniform beam color can be achieved. In addition, because all of the excitation light sources are arranged on a plane parallel to the first surface S1, the arrangement of the heat dissipation element (not shown) of the illumination assembly 100 can be simplified. The excitation light sources can emit the first beam B1 and the second beam B2 simultaneously or sequentially. In addition, as shown in FIG. 1, the main optical axis of the first beam B1 and the main optical axis of the second beam B2 incident to the first light guide triangular prism 121 in parallel with each other.

In this embodiment, the second surface S2 can include a first part P1 and a second part P2. The first part P1 is adjacent between the second part P2 and the first surface S1. The second part P2 is adjacent between the first part P1 and the beam-splitting surface DS1. The first light guide layer GL1 can be arranged on the first part P1 so that the first beam B1 undergoes total reflection when the first beam B1 is incident on the first part P1. In this embodiment, the first light guide layer GL1 can also be extended to the second part P2. In addition, when the first beam B1 and the second beam B2 incident to the second part P2, the second part P2 can be used for the first beam B1 and the second beam B2 to pass therethrough at an angle nearly perpendicular to the second surface S2. The first light guide layer GL1 is, for example, an anti-reflection layer. The first light guide layer GL1 is, for example, a light guide layer that can make one of the first beam B1 and the second beam B2 undergo total reflection, for example, a light guide layer that can make the red beam undergo total reflection.

In this embodiment, the first light guide triangular prism 121 may also have a third surface S3. The first surface S1, the second surface S2, and the third surface S3 are adjacent to each other and are the sides of the first light guide triangular prism 121. The first light guide triangular prism 121 is, for example, a regular triangular prism. It can be understood that the angles, side lengths, and other characteristics of the first light guide triangular prism 121 may have a slight difference with the regular triangular prism according to the actual manufacturing process, and the disclosure does not limit these details. In addition, the beam-splitting surface DS1 is located in the first light guide triangular prism 121, and the second surface S2 and the third surface S3 are symmetrical to the beam-splitting surface DS1. The first surface S1 is also located on the transmission path of the second beam B2. The first light guide triangular prism 121 also includes a second light guide layer GL2. The second light guide layer GL2 is arranged on the third surface S3. The second light guide layer GL2 is configured to guide the second beam B2 to the first beam-splitting layer DL1. Specifically, the second light guide layer GL2 is, for example, an anti-reflection layer. The second beam B2 undergoes total reflection when the second beam B2 is incident on the third surface S3. The first beam B1 and the second beam B2 can be respectively incident to the beam-splitting surface DS1, while the first beam-splitting layer DL1 located on the beam-splitting surface DS can reflect the first beam B1 to the second surface S2 and allow the second beam B2 to pass therethrough to incident to the second surface S2. In this way, the optical paths of the first beam B1 and the second beam B2 from the first beam-splitting layer DL1 can overlap at least partially, and both the first beam B1 and the second beam B2 exit from the second surface S2.

The first beam-splitting layer DL1 includes, for example, a dichroic layer. For example, when the first beam B1 is a red beam, the dichroic layer is configured to reflect the red beam and allow beams of other wavelengths to pass therethrough. It is noted that because the first beam B1 and the second beam B2 from the dichroic layer exit from the second surface S2 in the same direction (the first direction D1) and the optical paths of the first beam B1 and the second beam B2 can overlap at least partially, the light spot formed by the mixed beam formed by at least one of the first beam B1 and the second beam B2 with different wavelengths in other optical elements has the advantage of uniform color. In an embodiment, the first beam-splitting layer DL1 includes, for example, a polarization beam-splitting layer. For example, the first beam B1 and the second beam B2 are two polarized beams with the same color but different polarization directions, for example, the first beam B1 is p-polarized blue light and the second beam B2 is s-polarized blue light. The first light guide layer GL1 and the second light guide layer GL2 can make the p-polarized blue light and the s-polarized blue light undergo total reflection, respectively. The polarization beam-splitting layer can reflect the first beam B1 and allow the second beam B2 to pass therethrough. In addition, the light guide module 120 may also include, for example, an anti-reflection layer AL. The anti-reflection layer AL is arranged on the first surface S1 and configured to increase the amount of light of the first beam B1 and the second beam B2 entering into the first light guide triangular prism 121.

Compared with the conventional technology, the illumination assembly 100 of this embodiment can integrate a plurality of beams generated by the light source module 110 with one first light guide triangular prism 121, thus providing the advantages of small volume, simple structure, and low cost.

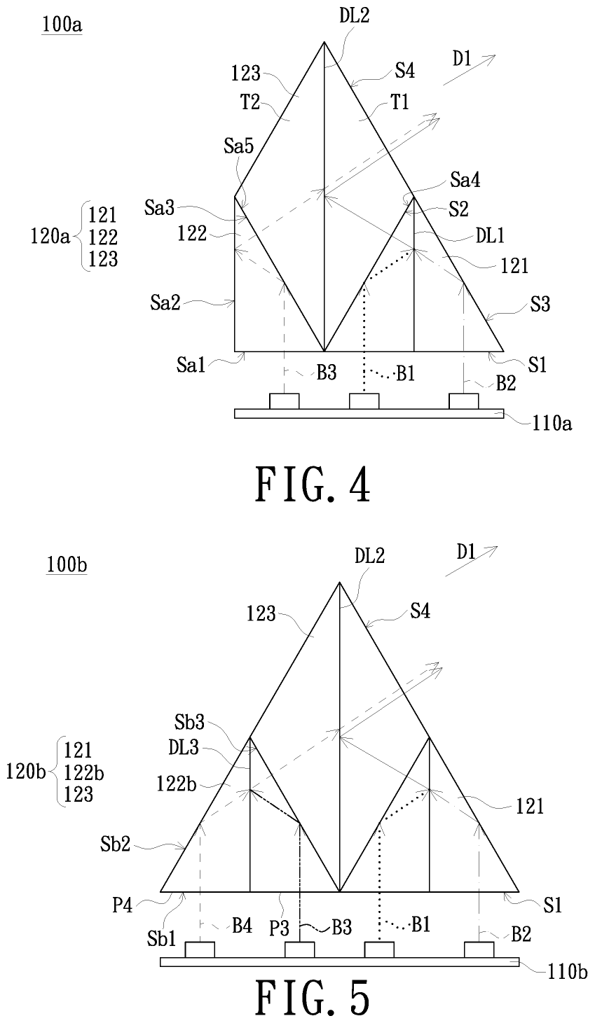

FIG. 4 is a schematic view of an illumination assembly according to another embodiment of the disclosure. The structure and advantages of the illumination assembly 100a of this embodiment are similar to those of the embodiment of FIG. 1, and only the differences will be described below. Referring to FIG. 4, the light guide module 120a may also include a second light guide triangular prism 122 and a diamond light guide prism 123. The light source module 110a is also configured, for example, to provide a third beam B3. In this embodiment, the excitation light sources corresponding to the first beam B1, the second beam B2, and the third beam B3 can be equidistant from each other. The diamond light guide prism 123 is arranged between the first light guide triangular prism 121 and the second light guide triangular prism 122. The diamond light guide prism 123 includes a second beam-splitting layer DL2. The second beam-splitting layer DL2 is arranged in the diamond light guide prism 123. The second light guide triangular prism 122 is located on the transmission path of the third beam B3. The second light guide triangular prism 122 is configured to guide the third beam B3 to the second beam-splitting layer DL2. The second beam-splitting layer DL2 is configured to reflect the first beam B1 and the second beam B2 from the second surface S2 and allow the third beam B3 to pass therethrough, so that the first beam B1, the second beam B2, and the third beam B3 exit from the fourth surface S4 of the diamond light guide prism 123. The first beam B1, the second beam B2, and the third beam B3 exit in the first direction D1, and the first direction D1 is perpendicular to the fourth surface S4. The fourth surface S4 is adjacent to, for example, the third surface S3 of the first light guide triangular prism 121, and the fourth surface S4 is parallel to the third surface S3.

The second light guide triangular prism 122 of this embodiment can be a right angle triangular prism. Further, the second light guide triangular prism 122 may have surfaces Sa1, Sa2, and Sa3. The surface Sa1 and the surface Sa2 may be perpendicular to each other, and the surface Sa1 may be coplanar with the first surface S1 of the first light guide triangular prism 121. In addition, the surface Sa3 is adjacent to the surfaces Sa1 and Sa2, and the surface Sa3 faces the diamond light guide prism 123. Specifically, the third beam B3 is incident to the surface Sa3 via the surface Sa1, and the third beam B3 undergoes a total reflection on the surface Sa3 and is incident to the surface Sa2. The third beam B3 is then reflected from the surface Sa2 to the surface Sa3, so that the third beam B3 passes through the surface Sa3 at an angle nearly perpendicular to the surface Sa3, and then enters the diamond light guide prism 123. In addition, the surface Sa1 can be provided with an anti-reflection layer to increase the amount of light of the third beam B3 entering into the second light guide triangular prism 122.

The second beam-splitting layer DL2 can be located in the diamond light guide prism 123 and arranged on the plane symmetrical to the diamond light guide prism 123, and the second beam-splitting layer DL2 is adjacent to the fourth surface S4. In this embodiment, the diamond light guide prism 123 can be formed by fitting two isosceles triangular prisms T1 and T2 together, and the fourth surface S4 is located on the isosceles triangular prism T1. The second beam-splitting layer DL2 can be arranged on one of the isosceles triangular prisms T1 and T2, and the isosceles triangular prism T1 and T2 are symmetrical to the second beam-splitting layer DL2. In detail, the isosceles triangular prism T1 can have a surface Sa4 adjacent to the fourth surface S4 and the second beam-splitting layer DL2, while the isosceles triangular prism T2 can have a surface Sa5 parallel to the fourth surface S4, and the surfaces Sa4 and Sa5 are symmetrical to the second beam-splitting layer DL2. Further, the surface Sa4 faces the second surface S2 of the first light guide triangular prism 121, and the first beam B1 and the second beam B2 enter the diamond light guide prism 123 from the surface Sa4 and incident to the second beam-splitting layer DL2. On the other hand, the surface Sa5 faces the surface Sa3 of the second light guide triangular prism 122, and the third beam B3 enters the diamond light guide prism 123 from the surface Sa5 and incident to the second beam-splitting layer DL2. The second beam-splitting layer DL2 can reflect the first beam B1 and the second beam B2 to the fourth surface S4 and can also allow the third beam B3 to pass therethrough and incident to the fourth surface S4. The first beam B1, the second beam B2, and the third beam B3 can all exit from the fourth surface S4, and the optical paths of the first beam B1, the second beam B2 and the third beam B3 from the second beam-splitting layer DL2 can overlap at least partially. In addition, the fourth surface S4 can be provided with an anti-reflection layer to increase the amount of the light of the first beam B1, the second beam B2, and the third beam B3 emitted from the diamond light guide prism 123.

In this embodiment, the first beam B1 may include a green beam, the second beam B2 may include a blue beam, and the third beam B3 may include a red beam. The first beam-splitting layer DL1 of this embodiment can reflect the green beam and allow the beams of other wavelengths to pass therethrough. The second beam-splitting layer DL2 can, for example, reflect the green beam and the blue beam and allow the beams of other wavelengths to pass therethrough. It is noted that the first beam B1, the second beam B2 and the third beam B3 from the second beam-splitting layer DL2 exit from the fourth surface S4 in the same direction (the first direction D1), and the optical paths of the first beam B1, the second beam B2 and the third beam B3 can overlap at least partially; thus, the light spot formed by the mixed beam formed by at least one of the first beam B1, the second beam B2 and the third beam B3 with different wavelengths in other optical elements has the advantage of uniform color.

FIG. 5 is a schematic view of an illumination assembly according to another embodiment of the disclosure. The structure and advantages of the illumination assembly 100b of this embodiment are similar to those of the embodiment of FIG. 4, and only the differences will be described below. Referring to FIG. 5, the light source module 110b is also configured to provide a fourth beam B4, for example. The second light guide triangular prism 122b of the light guide module 120b is arranged on the transmission path of the fourth beam B4. The second light guide triangular prism 122b includes a third beam-splitting layer DL3. The third beam-splitting layer DL3 is arranged in the second light guide triangular prism 122b. The third beam-splitting layer DL3 is configured to allow the fourth beam B4 to pass therethrough and reflect the third beam B3 so that the third beam B3 and the fourth beam B4 are guided to the second beam-splitting layer DL2 of the diamond light guide prism 123.

In detail, the second light guide triangular prism 122b is, for example, a regular triangular prism and can have surfaces Sb1, Sb2, and Sb3. The two sides of the surface Sb1 are adjacent to the surfaces Sb2 and Sb3 respectively, and the surfaces Sb2 and Sb3 can be symmetrical to the third optical beam-splitting layer DL3. The third beam B3 and the fourth beam B4 enter the second light guide triangular prism 122b from the surface Sb1, and the surface Sb1 in FIG. 5 can be coplanar with the first surface S1 of the first light guide triangular prism 121. In addition, the surface Sb3 can face the diamond light guide prism 123. Further, the surface Sb1 may have a third part P3 and a fourth part P4. The third part P3 and the fourth part P4 are located on opposite sides of the third beam-splitting layer DL3. The third beam B3 incidents on the surface Sb3 after the third beam B3 enters the second light guide triangular prism 122b via the third part P3. A light guide layer (not shown) is arranged on the surface Sb3. The third beam B3 may undergo total reflection when the third beam B3 incidents on the light guide layer, and the light guide layer is configured to guide the third beam B3 to the third beam-splitting layer DL3. The fourth beam B4 incidents on the surface Sb2 after the fourth beam B4 enters the second light guide triangular prism 122b via the fourth part P4. A light guide layer (not shown) is arranged on the surface Sb2, and the light guide layer can be configured to reflect the fourth beam B4 to the third beam-splitting layer DL3. The third beam-splitting layer DL3 can be configured to reflect the third beam B3 to the surface Sb3 and allow the fourth beam B4 to pass therethrough and incident on the surface Sb3 so that the third beam B3 and the fourth beam B4 both exit from the surface Sb3 at an angle nearly perpendicular to the surface Sb3 and enter the diamond light guide prism 123. In detail, the optical paths of the third beam B3 and the fourth beam B4 from the third beam-splitting layer DL3 may overlap at least partially. After the third beam B3 and the fourth beam B4 enter the diamond light guide prism 123, the second beam-splitting layer DL2 can allow the third beam B3 and the fourth beam B4 to pass therethrough to incident on the fourth surface S4 and can reflect the first beam B1 and the second beam B2 to the fourth surface S4, so that the first beam B1, the second beam B2, the third beam B3 and the fourth beam B4 all exit from the fourth surface S4.

In this embodiment, the first beam B1 may include a green beam, the second beam B2 may include a blue beam, the third beam B3 may include an orange beam, and the fourth beam B4 may include a red beam, for example. The third beam-splitting layer DL3 can be configured to reflect the orange beam and allow the beams of other wavelengths to pass therethrough. The second beam-splitting layer DL2, for example, can be configured to reflect the green beam and the blue beam and allow the beams of other wavelengths to pass therethrough. In an embodiment, the first mixed light formed by the first beam B1 and the second beam B2 with short wavelengths and the second mixed light formed by the third beam B3 and the fourth beam B4 with long wavelengths are respectively incident on the two sides of the diamond light guide prism 123, and the optical paths of the first mixed light and the second mixed light can overlap at least partially. Thus, a white beam can be formed after the first mixed light and the second mixed light pass through the diamond light guide prism 123. It is noted that the first beam B1, the second beam B2, the third beam B3 and the fourth beam B4 from the second beam-splitting layer DL2 emit from the fourth surface S4 in the same direction (the first direction D1), and the light paths of the beams can overlap at least partially; thus, the light spot formed by the mixed beam formed by at least one of the first beam B1, the second beam B2, the third beam B3 and the fourth beam B4 with different wavelengths in other optical elements has the advantage of uniform color. In addition, in this embodiment, the problem of red light speckles can be solved by providing the third beam B3 (orange beam) from the light source module 110b.

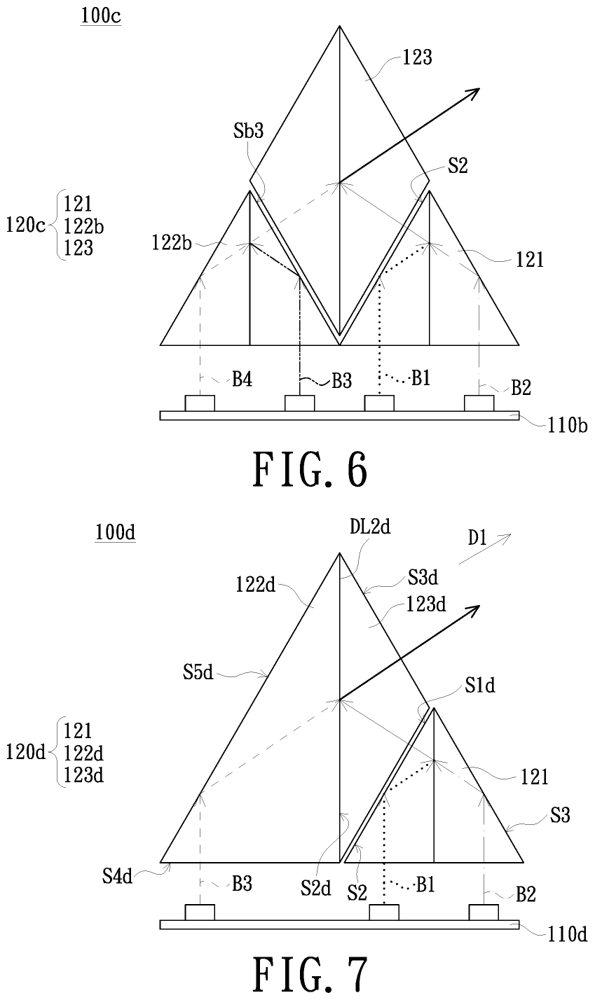

FIG. 6 is a schematic view of an illumination assembly according to another embodiment of the disclosure. The structure and advantages of the illumination assembly 100c of this embodiment are similar to those of the embodiment of FIG. 5, and only the differences will be described below. Referring to the light guide module 120c of FIG. 6, there may be a distance between the diamond light guide prism 123 and the first light guide triangular prism 121, and there may also be a distance between the diamond light guide prism 123 and the second light guide triangular prism 122b. Specifically, the diamond light guide prism 123 has a distance (i.e., air gap) from the second surface S2 of the first light guide triangular prism 121 and a distance (i.e., air gap) from the surface Sb3 of the second light guide triangular prism 122b. In this way, the first beam B1 is more likely to undergo total reflection on the second surface S2, and the third beam B3 is more likely to undergo total reflection on the surface Sb3, thereby increasing the light utilization. The specific value of the aforementioned distance can be determined according to the actual demand, so the disclosure does not limit the value of the aforementioned distance. In addition, returning to FIG. 4, the diamond light guide prism 123 in FIG. 4 can also have a distance from the first light guide triangular prism 121 and a distance from the second light guide triangular prism 122b.

FIG. 7 is a schematic view of an illumination assembly according to another embodiment of the disclosure. The structure and advantages of the illumination assembly 100d of this embodiment are similar to those of the embodiment of FIG. 6, and only the differences will be described below. Referring to FIG. 7, the light source module 110d of this embodiment can be configured to provide the first beam B1, the second beam B2, and the third beam B3. The position where the light source module 110d generates the third beam B3 is slightly different from that of the embodiment of FIG. 6. In this embodiment, the second light guide triangular prism 122d is located on the transmission path of the third beam B3. The second light guide triangular prism 122d includes a second beam-splitting layer DL2d. The second beam-splitting layer DL2d is arranged on the side of the second light guide triangular prism 122d. The second beam-splitting layer DL2d is configured to allow the third beam B3 to pass therethrough and reflect the first beam B1 and the second beam B2 from the second surface S2, so that the first beam B1, the second beam B2 and the third beam B3 exit in the first direction D1, wherein the first direction D1 is perpendicular to the third surface S3. In addition, the light guide module 120d may also include a third light guide triangular prism 123d. The third light guide triangular prism 123d may be located between the first light guide triangular prism 121 and the second light guide triangular prism 122d.

In detail, the third light guide triangular prism 123d has surfaces S1d, S2d, and S3d adjacent to each other. The surface S1d faces the second surface S2 of the first light guide triangular prism 121, and the first beam B1 and the second beam B2 incident on the third light guide triangular prism 123d from the surface S1d. In addition, the surface S2d is arranged to face the second beam-splitting layer DL2d of the second light guide triangular prism 122d. In addition, the surface S3d is parallel to the third surface S3 of the first light guide triangular prism 121. The second light guide triangular prism 122d is, for example, a right angle triangular prism and has surfaces S4d and S5d. The second beam-splitting layer DL2d is, for example, adjacent between the surfaces S4d and S5d.

Further, the third beam B3 incidents to the surface S5d from the surface S4d. A light guide layer (not shown) is arranged on the surface S5d. The light guide layer can be configured to reflect the third beam B3 to the second beam-splitting layer DL2d. Because the second beam-splitting layer DL2 can be configured to reflect the first beam B1 and the second beam B2 to the surface S3d and allow the third beam B3 to pass therethrough and incident to the surface S3d, the first beam B1, the second beam B2 and the third beam B3 can all exit from the surface S3d.

In this embodiment, the first beam B1 may include a green beam, the second beam B2 may include a blue beam, and the third beam B3 may include a red beam. The second beam-splitting layer DL2d can, for example, reflect the green beam and the blue beam and allow the beams of other wavelengths to pass therethrough. The light spot formed by the mixed beam formed by at least one of the first beam B1, the second beam B2, and the third beam B3 with different wavelengths in other optical elements has the advantage of uniform color.

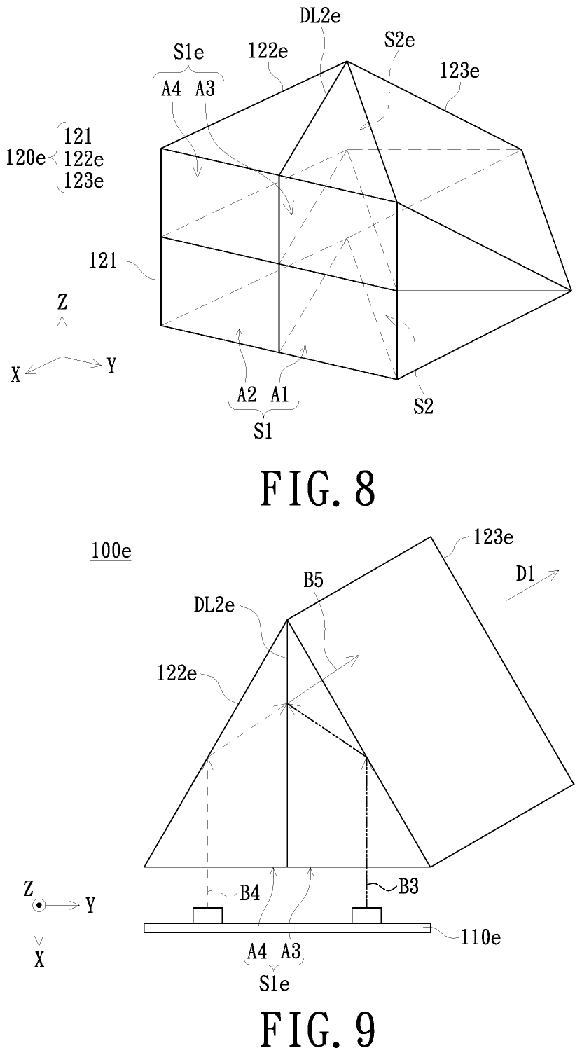

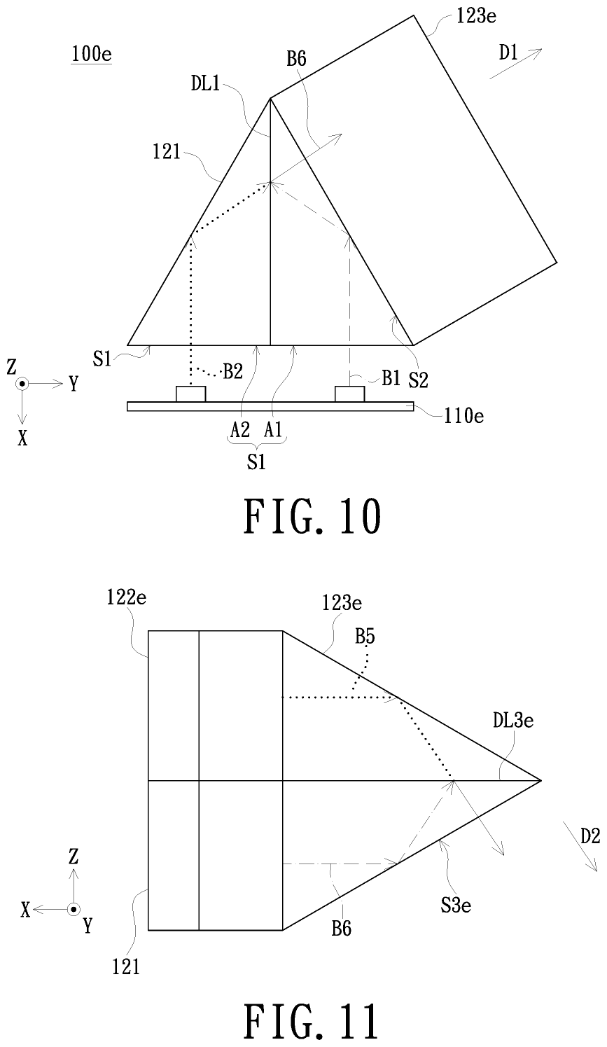

FIG. 8 is a schematic view of a light guide module according to another embodiment of the disclosure. FIGS. 9, 10 and 11 are schematic views of an illumination assembly according to another embodiment of the disclosure in different viewing angles. The viewing angle relationships between FIGS. 8, 9, 10, and 11 are presented in directions X, Y, and Z. The structure and advantages of the illumination assembly 100e of this embodiment are similar to those of the embodiment of FIG. 1, and only the differences will be described below. Referring to FIGS. 8, 9 and 10, the light guide module 120e may also include a second light guide triangular prism 122e and a light guide element 123e. The light source module 110e is configured, for example, to provide a first beam B1, a second beam B2, a third beam B3, and a fourth beam B4. The second light guide triangular prism 122e is arranged on the transmission paths of the third beam B3 and the fourth beam B4. The second light guide triangular prism 122e is configured to make the third beam B3 and the fourth beam B4 emit in the first direction D1, wherein the first direction D1 is perpendicular to the second surface S2 (shown in FIG. 8). The second light guide triangular prism 122e is attached to the first light guide triangular prism 121. The light guide element 123e is arranged on the transmission paths of the first beam B1 and the second beam B2 from the first light guide triangular prism 121 and the third beam B3 and the fourth beam B4 from the second light guide triangular prism 122e. Referring to FIG. 11, the light guide element 123e is configured to guide the first beam B1, the second beam B2, the third beam B3, and the fourth beam B4 to exit in the second direction D2, wherein the second direction D2 is not parallel to the first direction D1 (shown in FIGS. 9 and 10).

Refer to FIG. 8 again. In detail, the first surface S1 of the first light guide triangular prism 121 can have a first block A1 and a second block A2. The first block A1 can be used for the incidence of the first beam B1 (shown in FIG. 10), and the second block A2 can be used for the incidence of the second beam B2 (shown in FIG. 10). In addition, the second light guide triangular prism 122e may have a second beam-splitting layer DL2e, surface S1e and surface S2e. The second beam-splitting layer DL2e is adjacent between the surfaces S1e and S2e. The surface S1e may have a third block A3 and a fourth block A4. Specifically, the third block A3 and the fourth block A4 are located on opposite sides of the second beam-splitting layer DL2e. The third block A3 is adjacent to the first block A1 and the fourth block A4. The second block A2 is adjacent to the third block A3 and the fourth block A4. In this embodiment, the third beam B3 (shown in FIG. 9) is incident from the third block A3, and the fourth beam B4 (shown in FIG. 9) is incident from the fourth block A4. On the other hand, the surface S2e of the second light guide triangular prism 122e is adjacent to the second surface S2 of the light guide module 120e, and both the surface S2e and the second surface S2 face the light guide element 123e so that the beams from the first light guide triangular prism 121 and the second light guide triangular prism 122e can be incident to the light guide element 123e.

Refer to FIG. 9 again. The third beam B3 and the fourth beam B4 can enter the second light guide triangular prism 122e from the surface S1e; and similar to the first light guide triangular prism 121, the third beam B3 and the fourth beam B4 are reflected to the second beam-splitting layer DL2e in the second light guide triangular prism 122e respectively. The second beam-splitting layer DL2e can be configured to reflect the third beam B3 and allow the fourth beam B4 to pass therethrough. At least one of the third beam B3 and the fourth beam B4 from the second beam-splitting layer DL2e forms the fifth beam B5, and the fifth beam B5 passes through the surface S2e in the first direction D1 and enters the light guide element 123e. Refer to FIG. 10 again. At least one of the first beam B1 and the second beam B2 from the first beam-splitting layer DL1 of the first light guide triangular prism 121 forms the sixth beam B6, and the sixth beam B6 passes through the second surface S2 in the first direction D1 and enters the light guide element 123e. The first direction D1 is, for example, perpendicular to the second surface S2 and the surface S2e (shown in FIG. 9).

Refer to FIG. 11 again. The light guide element 123e of this embodiment can be a light guide triangular prism with a third beam-splitting layer DL3e, a beam-splitting mirror, or at least one mirror. Further, after entering the light guide element 123e, the fifth beam B5 and the sixth beam B6 can be reflected to the third beam-splitting layer DL3e. The third beam-splitting layer DL3e can be configured to reflect the sixth beam B6 and allow the fifth beam B5 to pass therethrough. In this way, both the fifth beam B5 and the sixth beam B6 can exit from the surface S3e in the second direction D2. The second direction D2 is, for example, perpendicular to the surface S3e.

Refer to FIGS. 8, 9, and 10 together. In this embodiment, the first beam B1 can include a green beam, the second beam B2 can include a blue beam, the third beam B3 can include an orange beam, and the fourth beam B4 can include a red beam, for example. Therefore, the second beam-splitting layer DL2e of this embodiment can reflect the orange beam and allow the beams of other wavelengths to pass therethrough. The first beam-splitting layer DL1 can, for example, reflect the green beam and allow the beams of other wavelengths to pass therethrough. In addition, the sixth beam B6 includes at least one of the green beam and the blue beam, and the third beam-splitting layer DL3e can be configured to reflect the green beam and the blue beam and allow the beams of other wavelengths to pass therethrough. Referring to FIG. 11 again, it is noted that the fifth beam B5 and the sixth beam B6 from the third beam-splitting layer DL3e exit from the surface S3e in the same direction (the second direction D2), and the optical paths of the fifth beam B5 and the sixth beam B6 can overlap at least partially. Therefore, the light spot formed by the mixed beam formed by at least one of the fifth beam B5 and the sixth beam B6 with different wavelengths in other optical elements has the advantage of uniform color. In addition, in this embodiment, because the light source module 110e is designed to arrange a plurality of excitation light sources perpendicular to the direction X, the volume of the illumination assembly 100e can be effectively reduced. In this embodiment, the light source module 110e can be arranged in a square array, which can achieve the effect that the beam has uniform brightness.

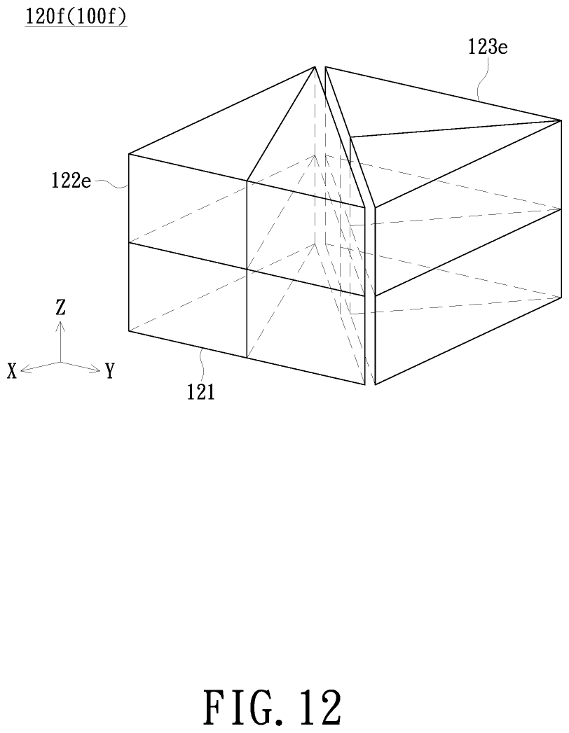

In addition, referring to the light guide module 120f of FIG. 12, the light guide element 123e may have a distance from the first light guide triangular prism 121 and a distance from the second light guide triangular prism 122e. In this way, the effect of the first light guide triangular prism 121 and the second light guide triangular prism 122e on the total reflection of the beam can be further improved, thereby increasing the light utilization.

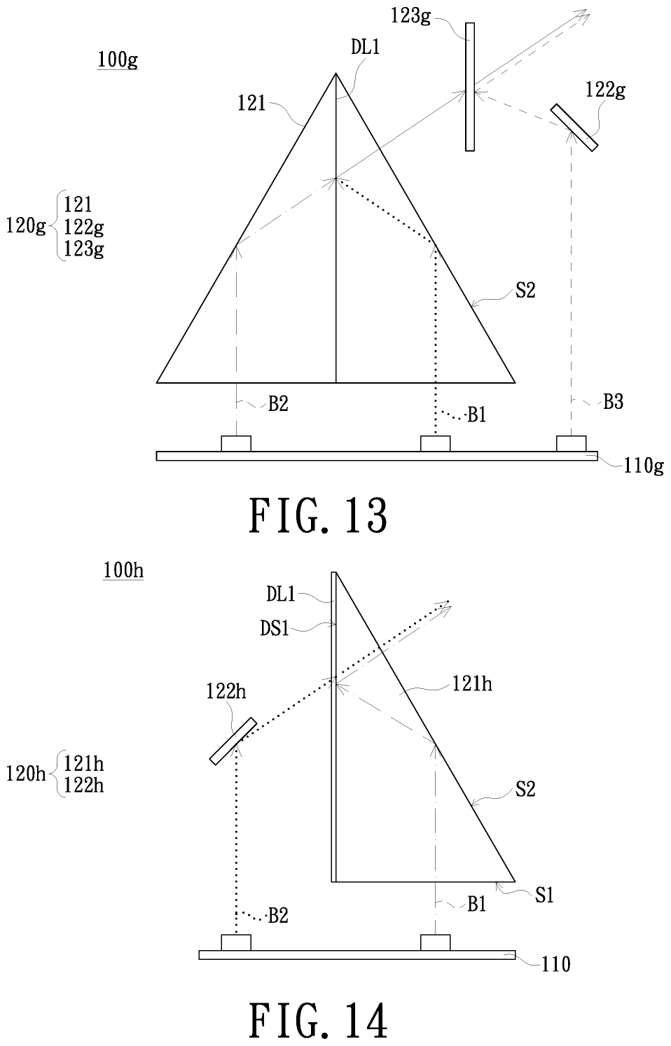

FIG. 13 is a schematic view of an illumination assembly according to another embodiment of the disclosure. The structure and advantages of the illumination assembly 100g of this embodiment are similar to those of the embodiment of FIG. 1, and only the differences will be described below. Referring to FIG. 13, the light guide module 120g may also include a reflecting element 122g and a beam-splitting element 123g. The light source module 110g is configured to provide the first beam B1, the second beam B2 and the third beam B3, for example. The reflecting element 122g is arranged on the transmission path of the third beam B3. The reflecting element 122g is configured to reflect the third beam B3 to the beam-splitting element 123g. The beam-splitting element 123g is configured to allow the third beam B3 to pass therethrough and reflect the first beam B1 and the second beam B2 from the second surface S2 of the first light guide triangular prism 121. The reflecting element 122g is, for example, a reflector or a glass with a reflective layer. In this embodiment, the first beam B1 may include a green beam, the second beam B2 may include a blue beam, and the third beam B3 may include a red beam, for example. The beam-splitting element 123g can be configured to, for example, reflect the red beam and allow the beams of other wavelengths to pass therethrough. The light spot formed by the mixed beam formed by at least one of the first beam B1, the second beam B2 and the third beam B3 with different wavelengths in other optical elements has the advantage of uniform color.

FIG. 14 is a schematic view of an illumination assembly according to another embodiment of the disclosure. The structure and advantages of the illumination assembly 100h of this embodiment are similar to those of the embodiment of FIG. 1, and only the differences will be described below. Referring to FIG. 14, the light guide module 120h may also include a reflecting element 122h. The reflecting element 122h is located on the transmission path of the second beam B2. The reflecting element 122h is configured to reflect the second beam B2 to the first beam-splitting layer DL1. The first surface S1, the second surface S2 and the beam-splitting surface DS1 of the first light guide triangular prism 121h are adjacent to each other and are the sides of the first light guide triangular prism 121h. In this embodiment, the first light guide triangular prism 121h is, for example, a right angle triangular prism. The second beam B2 is reflected by the reflecting element 122h to the beam-splitting surface DS1 and enters the first light guide triangular prism 121h from the beam-splitting surface DS1. After the second beam B2 enters the first light guide triangular prism 121h, the first beam-splitting layer DL1 can guide the first beam B1 and the second beam B2 to the second surface S2, and then the first beam B1 and the second beam B2 exit from the second surface S2. In this embodiment, the reflecting element 122h is, for example, a reflector or a glass with a reflective layer. In addition, in this embodiment, the volume of the first light guide triangular prism 121h can be reduced by the reflecting element 122h, so the cost can be reduced.

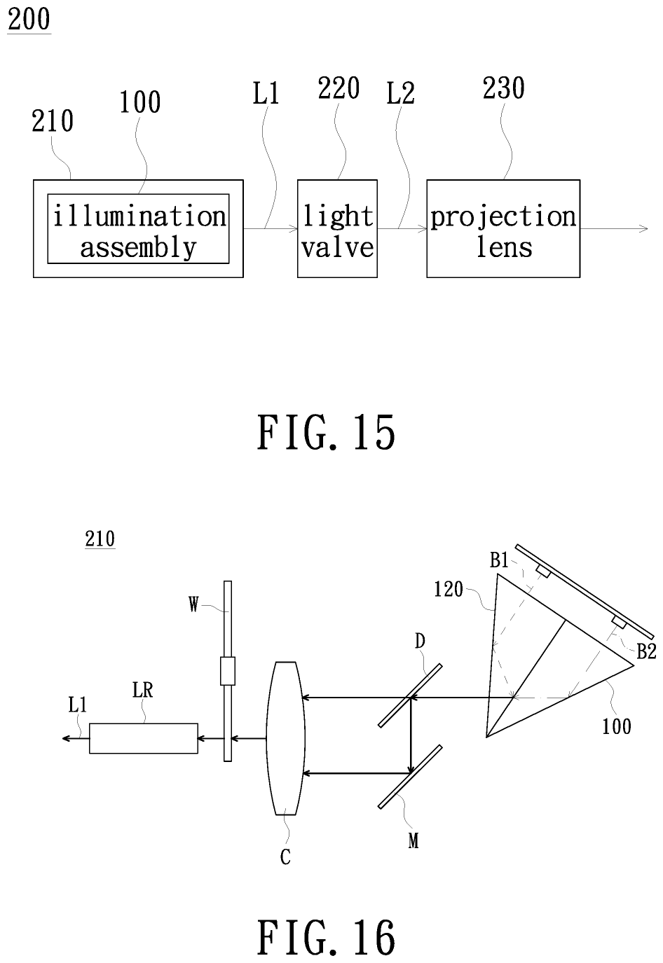

FIG. 15 is a block diagram of a projection device according to an embodiment of the disclosure. Referring to FIG. 15, the projection device 200 includes the aforementioned illumination system 210, a light valve 220, and a projection lens 230. The illumination assembly is configured to provide an illumination beam L1. The light valve 220 is arranged on the transmission path of the illumination beam L1 and configured to convert the illumination beam L1 into an image beam L2. The projection lens 230 is arranged on the transmission path of the image beam L2 and configured to project the image beam L2 out of the projection device 200. The illumination system 210 may include the aforementioned illumination assemblies 100, 100a, 100b, 100c, 100d, 100e, 100f, 100g, or 100h, and this embodiment is exemplified by the illumination assembly 100 of FIG. 1.

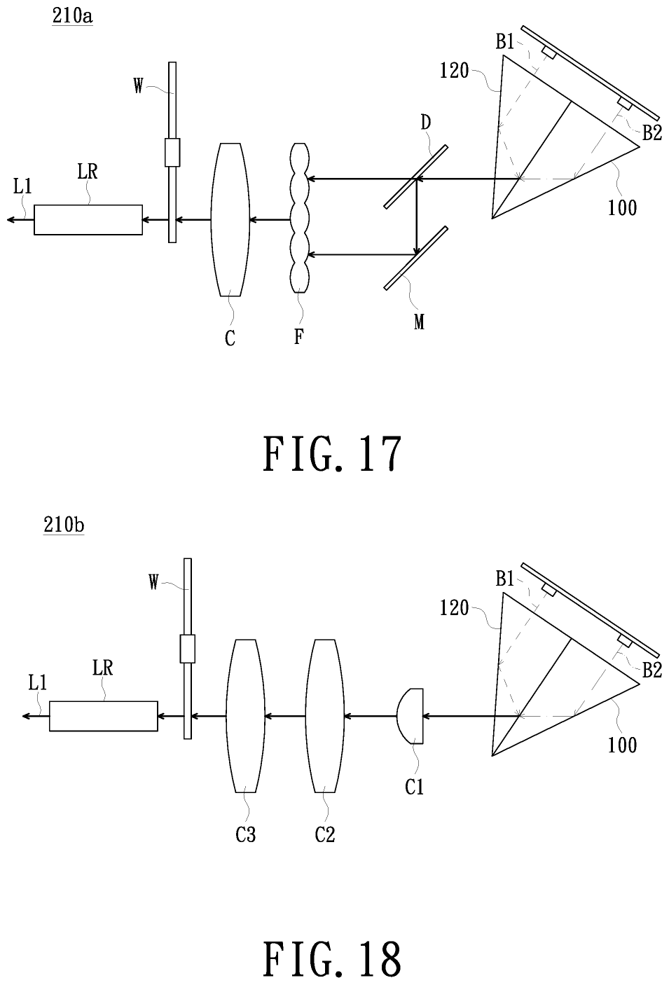

Refer to FIGS. 15 and 16 together. In this embodiment, the illumination beam L1 provided by the illumination system 210 may include at least one of the first beam B1 and the second beam B2. In addition, the illumination system 210 may also include a plurality of optical elements located on the transmission paths of the first beam B1 and the second beam B2 as the source of the illumination beam L1. For example, a beam-splitting element D, a reflecting element M, a condensing lens C, an optical element W and a light homogenizing element LR can be arranged downstream of the optical path of the light guide module 120. In an embodiment as shown in FIG. 17, the illumination system 210a may also include a fly-eye lens F arranged downstream of the optical path of the beam-splitting element D and the reflecting element M. In another embodiment as shown in FIG. 18, the illumination system 210b may also include a cylindrical lens C1, condensing lenses C2 and C3, an optical element W and a light homogenizing element LR arranged downstream of the optical path of the light guide module 120. The optical element W may be, for example, a filter or a polarizer.

Refer to FIG. 15 again. The light valve 220 is, for example, a digital micromirror device (DMD), a liquid crystal on silicon (LCoS), or a liquid crystal display (LCD), but not limited thereto. In addition, the disclosure does not limit the quantity of the light valves 220. For example, the projection device 200 in an embodiment can adopt a single-chip liquid crystal display panel or a three-chip liquid crystal display panel structure, but the present disclosure is not limited thereto.

The projection lens 230 includes, for example, one or more optical lenses, and the diopters of the optical lenses may be the same or different from each other. For example, the aforementioned optical lenses may include a biconcave lens, a biconvex lens, a concave-convex lens, a convex-concave lens, a plano-convex lens, and a plano-concave lens, or any combination of the above non-planar lenses. On the other hand, the projection lens 230 may also include a flat optical lens. The present disclosure does not limit the specific structure of the projection lens 230.

Compared with the conventional art, by adopting the illumination assembly 100, the projection device 200 of this embodiment can have the advantages of small size, low cost, and good image quality.

In summary, in the disclosure, the light guide module of the illumination assembly adopts the first light guide triangular prism. The first beam and the second beam are guided to the first beam-splitting layer of the first light guide triangular prism. Further, the first beam-splitting layer can allow the second beam to pass therethrough and reflect the first beam so that the first beam and the second beam exit from the second surface. Therefore, the illumination assembly of the disclosure can integrate a plurality of beams generated by the light source module with a light guide triangular prism, thereby providing the advantages of small volume, simple structure and low cost. Because of adopting the aforementioned illumination assembly, the projection device of the disclosure can provide the advantages of small volume, simple structure and low cost.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the invention”, “the disclosure” or the like is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims. Furthermore, the terms such as the first beam, the second beam, the first light guide triangular prism, the second light guide triangular prism, the first surface, the second surface, the beam-splitting surface, the first light guide layer, the second light guide layer, the first direction and the second direction are only used for distinguishing various elements and do not limit the number of the elements.

What is claimed is:

1. An illumination assembly, comprising:
a light source module, configured to provide a first beam and a second beam; and
a light guide module, comprising a first light guide triangular prism, wherein the first light guide triangular prism has a first surface, a second surface and a beam-splitting surface, the first surface is located on a transmission path of the first beam, and the beam-splitting surface is located on a transmission path of the second beam;
wherein the first light guide triangular prism further comprises a first light guide layer and a first beam-splitting layer, the first light guide layer is arranged on the second surface, the first beam-splitting layer is arranged on the beam-splitting surface, the first light guide layer is configured to guide the first beam to the first beam-splitting layer, the first beam-splitting layer is configured to allow the second beam to pass therethrough and reflect the first beam, so that the first beam and the second beam are emitted from the second surface.

2. The illumination assembly according to claim 1, wherein the first light guide triangular prism further has a third surface, and the first surface, the second surface, and the third surface are adjacent to each other and the first surface, the second surface and the third surface are sides of the first light guide triangular prism, the beam-splitting surface is located in the first light guide triangular prism, the second surface and the third surface are symmetrical to the beam-splitting surface, the first surface is further located on the transmission path of the second beam, the first light guide triangular prism further comprises a second light guide layer, the second light guide layer is arranged on the third surface, and the second light guide layer is configured to guide the second beam to the first beam-splitting layer.

3. The illumination assembly according to claim 1, wherein the light guide module further comprises a second light guide triangular prism and a diamond light guide prism;
the light source module is further configured to provide a third beam;
the diamond light guide prism is arranged between the first light guide triangular prism and the second light guide triangular prism, the diamond light guide prism comprises a second beam-splitting layer, and the second beam-splitting layer is arranged in the diamond light guide prism;
the second light guide triangular prism is located on a transmission path of the third beam, and the second light guide triangular prism is configured to guide the third beam to the second beam-splitting layer;
wherein the second beam-splitting layer is configured to reflect the first beam and the second beam coining from the second surface and allow the third beam to pass therethrough, so that the first beam, the second beam and the third beam exit from a fourth surface of the diamond light guide prism, wherein the first beam, the second beam and the third beam exit in a first direction, and the first direction is perpendicular to the fourth surface.

4. The illumination assembly according to claim 3, wherein there is a distance between the diamond light guide prism and the first light guide triangular prism, and there is a distance between the diamond light guide prism and the second light guide triangular prism.

5. The illumination assembly according to claim 3, wherein the light source module is further configured to provide a fourth beam, the second light guide triangular prism is arranged on a transmission path of the fourth beam, the second light guide triangular prism comprises a third beam-splitting layer, the third beam-splitting layer is arranged in the second light guide triangular prism, the third beam-splitting layer is configured to allow the fourth beam to pass therethrough and reflect the third beam, so that the third beam and the fourth beam are guided to the second beam-splitting layer of the diamond light guide prism.

6. The illumination assembly according to claim 5, wherein the first light guide triangular prism and the second light guide triangular prism are regular triangular prisms.

7. The illumination assembly according to claim 1, wherein the light guide module further comprises a second light guide triangular prism;
the light source module is further configured to provide a third beam;
the second light guide triangular prism is located on a transmission path of the third beam, the second light guide triangular prism comprises a second beam-splitting layer, and the second beam-splitting layer is arranged on a side of the second light guide triangular prism;
wherein the second beam-splitting layer is configured to allow the third beam to pass therethrough and reflect the first beam and the second beam coining from the second surface, so that the first beam, the second beam and the third beam exit in a first direction, and the first direction is perpendicular to the third surface.

8. The illumination assembly according to claim 7, wherein the light guide module further comprises a third light guide triangular prism, and the third light guide triangular prism is located between the first light guide triangular prism and the second light guide triangular prism.

9. The illumination assembly according to claim 1, wherein the light guide module further comprises a second light guide triangular prism and a light guide element;
the light source module is further configured to provide a third beam and a fourth beam;
the second light guide triangular prism is arranged on transmission paths of the third beam and the fourth beam, the second light guide triangular prism is configured to make the third beam and the fourth beam emit in a first direction, the first direction is perpendicular to the second surface, and the second light guide triangular prism is attached to the first light guide triangular prism;
the light guide element is arranged on transmission paths of the first beam and the second beam coining from the first light guide triangular prism and on transmission paths of the third beam and the fourth beam coming from the second light guide triangular prism, the light guide element is configured to guide the first beam, the second beam, the third beam and the fourth beam to emit in a second direction, and the first direction and the second direction are not parallel to each other.

10. The illumination assembly according to claim 9, wherein there is a distance between the first light guide triangular prism and the light guide element, and there is a distance between the second light guide triangular prism and the light guide element.

11. The illumination assembly according to claim 1, wherein the light guide module further comprises a reflecting element and a beam-splitting element, and the light source module is further configured to provide a third beam;
the reflecting element is arranged on a transmission path of the third beam, the reflecting element is configured to reflect the third beam to the beam-splitting element, and the beam-splitting element is configured to allow the third beam to pass therethrough and reflect the first beam and the second beam from the second surface.

12. The illumination assembly according to claim 1, wherein the first beam-splitting layer comprises a dichroic layer or a polarization beam-splitting layer.

13. The illumination assembly according to claim 1, wherein the light guide module further comprises an anti-reflection layer, and the anti-reflection layer is arranged on the first surface.

14. The illumination assembly according to claim 1, wherein the light guide module further comprises a reflecting element, the reflecting element is located on the transmission path of the second beam, the reflecting element is configured to reflect the second beam to the first beam-splitting layer, and the first surface, the second surface and the beam-splitting surface of the first light guide triangular prism are adjacent to each other and are sides of the first light guide triangular prism.

15. A projection device, comprising an illumination system, a light valve, and a projection lens, the illumination system being configured to provide an illumination beam, the light valve being arranged on a transmission path of the illumination beam and configured to convert the illumination beam into an image beam, the projection lens being arranged on a transmission path of the image beam and configured to project the image beam out of the projection device, the illumination system comprising an illumination assembly, and the illumination assembly comprising:
a light source module, configured to provide a first beam and a second beam; and
a light guide module, comprising a first light guide triangular prism, wherein the first light guide triangular prism has a first surface, a second surface and a beam-splitting surface, the first surface is located on a transmission path of the first beam, and the beam-splitting surface is located on a transmission path of the second beam;
wherein the first light guide triangular prism further comprises a first light guide layer and a first beam-splitting layer, the first light guide layer is arranged on the second surface, the first beam-splitting layer is arranged on the beam-splitting surface, the first light guide layer is configured to guide the first beam to the first beam-splitting layer, the first beam-splitting layer is configured to allow the second beam to pass therethrough and reflect the first beam, so that the first beam and the second beam are emitted from the second surface.

16. The projection device according to claim 15, wherein the first light guide triangular prism further has a third surface, and the first surface, the second surface and the third surface are adjacent to each other and the first surface, the second surface and the third surface are sides of the first light guide triangular prism, the beam-splitting surface is located in the first light guide triangular prism, the second surface and the third surface are symmetrical to the beam-splitting surface, the first surface is further located on the transmission path of the second beam, the first light guide triangular prism further comprises a second light guide layer, the second light guide layer is arranged on the third surface, and the second light guide layer is configured to guide the second beam to the first beam-splitting layer.

17. The projection device according to claim 15, wherein the light guide module further comprises a second light guide triangular prism and a diamond light guide prism;
the light source module is further configured to provide a third beam;
the diamond light guide prism is arranged between the first light guide triangular prism and the second light guide triangular prism, the diamond light guide prism comprises a second beam-splitting layer, and the second beam-splitting layer is arranged in the diamond light guide prism;
the second light guide triangular prism is located on a transmission path of the third beam, and the second light guide triangular prism is configured to guide the third beam to the second beam-splitting layer;
wherein the second beam-splitting layer is configured to reflect the first beam and the second beam coining from the second surface and allow the third beam to pass therethrough, so that the first beam, the second beam and the third beam exit from a fourth surface of the diamond light guide prism, wherein the first beam, the second beam and the third beam exit in a first direction, and the first direction is perpendicular to the fourth surface.

18. The projection device according to claim 17, wherein there is a distance between the diamond light guide prism and the first light guide triangular prism, and there is a distance between the diamond light guide prism and the second light guide triangular prism.

19. The projection device according to claim 17, wherein the light source module is further configured to provide a fourth beam, the second light guide triangular prism is arranged on a transmission path of the fourth beam, the second light guide triangular prism comprises a third beam-splitting layer, the third beam-splitting layer is arranged in the second light guide triangular prism, the third beam-splitting layer is configured to allow the fourth beam to pass therethrough and reflect the third beam, so that the third beam and the fourth beam are guided to the second beam-splitting layer of the diamond light guide prism.

20. The projection device according to claim 15, wherein the light guide module further comprises a second light guide triangular prism;
the light source module is further configured to provide a third beam;
the second light guide triangular prism is located on a transmission path of the third beam, the second light guide triangular prism comprises a second beam-splitting layer, and the second beam-splitting layer is arranged on a side of the second light guide triangular prism;
wherein the second beam-splitting layer is configured to allow the third beam to pass therethrough and reflect the first beam and the second beam coining from the second surface, so that the first beam, the second beam and the third beam exit in a first direction, and the first direction is perpendicular to the third surface.

21. The projection device according to claim 20, wherein the light guide module further comprises a third light guide triangular prism, and the third light guide triangular prism is located between the first light guide triangular prism and the second light guide triangular prism.

22. The projection device according to claim 15, wherein the light guide module further comprises a second light guide triangular prism and a light guide element;
the light source module is further configured to provide a third beam and a fourth beam;
the second light guide triangular prism is arranged on transmission paths of the third beam and the fourth beam, the second light guide triangular prism is configured to make the third beam and the fourth beam emit in a first direction, the first direction is perpendicular to the second surface, and the second light guide triangular prism is attached to the first light guide triangular prism;
the light guide element is arranged on transmission paths of the first beam and the second beam coining from the first light guide triangular prism and on transmission paths of the third beam and the fourth beam coming from the second light guide triangular prism, the light guide element is configured to guide the first beam, the second beam, the third beam and the fourth beam to emit in a second direction, and the first direction and the second direction are not parallel to each other.

23. The projection device according to claim 15, wherein the light guide module further comprises a reflecting element and a beam-splitting element, and the light source module is further configured to provide a third beam;
the reflecting element is arranged on a transmission path of the third beam, the reflecting element is configured to reflect the third beam to the beam-splitting element, and the beam-splitting element is configured to allow the third beam to pass therethrough and reflect the first beam and the second beam from the second surface.

24. The projection device according to claim 15, wherein the light guide module further comprises a reflecting element, the reflecting element is located on the transmission path of the second beam, the reflecting element is configured to reflect the second beam to the first beam-splitting layer, and the first surface, the second surface and the beam-splitting surface of the first light guide triangular prism are adjacent to each other and are sides of the first light guide triangular prism.
